(19) United States
(12) Patent Application Publication
(10) Pub. No.: US 2020/0359542 A1
(43) Pub. Date: Nov. 19, 2020

(54) METHOD FOR AGRICULTURAL SOIL CULTIVATION, TOOL SYSTEM, GENERATOR MODULE, AND THEIR USE

(71) Applicant: Technische Universität Dresden, Dresden (DE)

(72) Inventors: Tim BÖGEL, Dresden (DE); Matthias MARSEL, Freital (DE); Thomas HERLITZIUS, Coswig (DE)

(21) Appl. No.: 16/872,655

(22) Filed: May 12, 2020

(30) Foreign Application Priority Data
May 16, 2019 (DE) 10 2019 112 958.3

(51) Int. Cl. A01B 63/111; A01B 79/00; A01B 76/00; A01B 49/04

(52) U.S. Cl. CPC A01B 63/1112; A01B 49/04; A01B 76/00; A01B 79/005

(57) ABSTRACT

Different aspects of the disclosure relate to a device and a method for agricultural soil cultivation with the aid of a soil cultivation unit. The method can include, for example: ascertaining an actual soil cultivation result in a soil cultivation area cultivated with the aid of the soil cultivation unit; ascertaining a deviation of the actual soil cultivation result from a setpoint soil cultivation result; and reducing a deviation of the actual soil cultivation result from the setpoint soil cultivation result with the aid of an adaptation of a rotational speed of a rotatably mounted soil cultivation tool.

### CROSS-REFERENCE TO RELATED APPLICATIONS

This application claims priority to German patent application 10 2019 112 958.3, filed on May 16, 2019, the entirety of which is hereby incorporated fully by reference.

### TECHNICAL FIELD

Different exemplary aspects of the disclosure relate to a method for agricultural soil cultivation, a tool system, a generator module, and the use of the generator module and the tool system in connection with a carrier vehicle and method thereof.

### BACKGROUND

Generally speaking, an agricultural soil cultivation device, such as a rotary harrow, a rotary tiller, etc., can process the soil with the aid of a rotating tool, wherein the mechanical rotational speed is constant and is not controlled by a closed-loop system during the process. For example, an agricultural soil cultivation device can be adapted to a specific soil cultivation method to be carried out therewith. However, conventional agricultural soil cultivation devices cannot respond, in an efficient way, to external effects (such as the soil condition, the vegetation, the moisture, the cultivation speed, the cultivation depth, etc.) or interferences during the soil cultivation process. Therefore, conventional soil cultivation devices can reach their application limits or not carry out different soil cultivation methods with a high efficiency as agricultural methods change (for example, foregoing the plow, foregoing the use of chemicals, vegetation, climate change).

### BRIEF SUMMARY

A soil cultivation device and a method for soil cultivation are described in the following, wherein the work result is affected or can be affected during the soil cultivation. The soil cultivation device described herein is designed, for example, in such a way that it has a low specific energy requirement during the soil cultivation. Moreover, the soil cultivation device described herein can be designed in such a way that a comparatively high rate of work can be achieved during the soil cultivation, for example, greater than 1 ha/h·m_{working-width}. Moreover, the soil cultivation device described herein can be designed in such a way that a comparatively high operating speed is made possible, for example, greater than 6 km/h or greater than 10 km/h.

Conventional passively drawn soil cultivation devices, such as a plow, a cultivator, a disk harrow, etc., can allow for comparatively high rates of work, since such soil cultivation devices can be designed for high operating speeds, although this also requires high tractive forces on the part of the towing vehicle. As a result, the powerful towing vehicles required are equipped with appropriate additional weights, in order, for example, to generate the necessary driving force. Such vehicle/equipment combinations therefore also substantially contribute to a generally harmful ground compression, however. The specific machine weight of such vehicle/equipment combinations for soil cultivation can be, for example, considerably greater than is the case for actively driven soil cultivation devices.

Herein, a soil cultivation device and a method for soil cultivation are described, wherein the soil cultivation device includes one or multiple active, electrically driven tool(s) for soil cultivation and, optionally, an auxiliary drive in the form of an electrically driven trailing tool for relieving the strain on a towing vehicle. The electric drives, which affect the soil cultivation result, can be controlled with the aid of a closed-loop system in order to ensure a predefined soil cultivation result despite external effects or interferences. A predefined soil cultivation result can also be referred to in this case as a setpoint soil cultivation result.

### BRIEF DESCRIPTION OF THE DRAWINGS

Exemplary aspects of the disclosure are represented in the figures and are explained in greater detail in the following.

Wherein

FIG. 1 shows a tool system in a schematic view, according to different aspects of the disclosure;

FIG. 2 shows a schematic flow chart of a method for agricultural soil cultivation with the aid of a soil cultivation unit, according to different aspects of the disclosure;

FIG. 3 shows a schematic flow chart of a method for agricultural soil cultivation with the aid of a soil cultivation unit, according to different aspects of the disclosure;

FIG. 4 shows a sensor system in a schematic representation, according to different aspects of the disclosure;

FIG. 5 through FIG. 7 show different configurations of a soil cultivation unit, each in a schematic representation, according to different aspects of the disclosure;

FIG. 8A shows a generator module in a schematic representation, according to different aspects of the disclosure;

FIG. 8B shows a carrier vehicle including a generator module and a tool system coupled to the carrier vehicle in a schematic representation, according to different aspects of the disclosure;

FIG. 8C shows a carrier vehicle and a tool system coupled to the carrier vehicle in a schematic representation, according to different aspects of the disclosure;

FIG. 9A shows a vehicle/equipment combination made up of a carrier vehicle and a tool system, wherein the tool system is supplied with the aid of a generator module, in a schematic representation, according to different aspects of the disclosure; and

FIG. 9B shows exemplary power distributions and communication paths of a vehicle/equipment combination made up of a carrier vehicle and a tool system, wherein the tool system is supplied with the aid of a generator module, according to different aspects of the disclosure.

### DESCRIPTION

In the following extensive description, reference is made to the attached drawings, which form a part of this description and in which specific aspects of the disclosure in which the subject-matter of the disclosure can be applied are shown, for purposes of illustration. It is clear that other aspects of the disclosure can be used and structural or logical changes can be made without deviating from the scope of protection of the present disclosure. It is clear that the features of the different exemplary aspects of the disclosure described herein can be combined with one another, unless specifically indicated otherwise elsewhere. The following description should therefore not be interpreted to be limiting, and the scope of protection of the present disclosure is defined by the attached claims.

Different aspects of the disclosure are related to a tool system for agricultural soil cultivation, wherein the tool system is designed in such a way that it has a low tractive force requirement and a low machine weight. The tool system is, for example, modularly designed and can be adapted, in an efficient way, to a soil cultivation method to be carried out, as illustrated, for example, in FIGS. 5 through 7.

Due to the operating principle of the soil cultivation unit—described herein—of the tool system, the tool system can be utilized in different agricultural soil cultivation methods (for example, crop residue breaking, liquid fertilizer incorporation, mechanical weeding, seedbed preparation, etc.). The particular towing vehicle or a carrier vehicle can be relieved of heavy pulling work with the aid of a tractive force-reducing working process and, optionally, with the aid of driving force-generating trailing elements. The work result of the tool system in the cultivated soil area can be detected with the aid of at least one sensor and appropriately evaluated with the aid of a computer system. Based on pieces of information regarding the generated work result, for example, the rotational speed of an electromechanical drive can be adapted. As a result, for example, the work result as well as the power requirement of the tool system or of the soil cultivation unit of the tool system can be actively controlled with the aid of an open-loop or closed-loop system.

According to different aspects of the disclosure, the soil cultivation unit can include an electromechanical drive train in combination with at least one sensor for determining the work result (for example, the soil roughness) as well as the generation of a driving-force controlled by an open-loop system at the trailing element. The pieces of sensor information can be utilized, for example, for adjusting the driving speed of a tine rotor in such a way that a constant (for example, predefined) work result can be achieved. In order to relieve the carrier vehicle of tractive force, the trailing tool can also be electrically driven, in order to generate tractive force, and can be appropriately controlled by an open-loop system. According to different aspects of the disclosure, the electric power can be made available with the aid of a flexibly mountable generator module. The generator module may be mounted between the carrier vehicle and the tool system. According to different aspects of the disclosure, the generator module may be configured for being coupled to or mounted on a carrier vehicle as well as for the coupling or mounting of the soil cultivation device with the aid of appropriate standardized mechanical interfaces. Moreover, the generator module may convert a portion of the mechanical P.T.O power of the carrier vehicle into electric power with the aid of a generator.

According to different aspects of the disclosure, the generator module may be configured in such a way that a portion of the mechanical power may be passed through from a transmission to the soil cultivation device. The generator module may provide two types of energy to the coupled working devices, as necessary, and may include the power and control electronics system necessary therefor. Pieces of process information (such as the rotational speed of the tine rotor, the torque of the tine rotor, the rotational speed of the trailing tool, and/or the torque of the trailing tool) may be evaluated with the pieces of sensor information of the work result and/or processed in an automatic machine controller. Moreover, the work result may be referenced in a location-specific manner (per GPS) and recorded for documentation and/or evaluation.

The agricultural soil cultivation machine described herein can be used flexibly and energy-efficiently in different agricultural processes. According to different aspects of the disclosure, an at least partial autonomization of the working process may also take place for improved work results under fluctuating, location-specific operating conditions. According to different aspects of the disclosure, a detection (for example, a real-time detection) and a documentation of the subplot-specific process parameters may take place. According to different aspects of the disclosure, the tool system may be made available in such a way that a compatibility with existing vehicles may be ensured (for example, a compatibility with respect to the power supply, the open-loop control via wireless or wired communication, and/or the particular data BUS standard that is utilized). For example, a communication per the ISOBUS standard may be implemented.

Different aspects of the disclosure relate to a method and an appropriate device whose mode of operation can be based on a tool combination made up of passively drawn loosening elements and an actively (for example, electrically) driven, rotating tine rotor. The work result that is achieved may be adapted by adjusting the rotational speed of the tine rotor. At least one sensor, for example, may be installed for ascertaining the work result that is achieved. With the aid of the at least one sensor, for example, the soil roughness can be measured and these measuring data can be made available to the open-loop/closed-loop control of the tine rotor. The open-loop/closed-loop control can also control, by way of an open-loop or closed-loop system, the work result of the working device under fluctuating conditions, in a subplot-specific manner, depending on the process objective required by the user (operator). In order to adjust the rotational speed, for example, an electromechanical drive train can be utilized, which is optionally supplied with electric power by a modular generator unit or a carrier vehicle. This generator unit may be coupled between the carrier vehicle and the working device. The at least one trailing tool of the working device may be, optionally, electrically driven and, for example, generate a driving force with the aid of the superimposed load (i.e., the machine weight). The open-loop/closed-loop control of the working device as well as of the generator module may take place, for example, per the ISOBUS standard via the terminal installed on the carrier vehicle and/or, for example, wirelessly with the aid of a mobile terminal (for example, a smartphone, a tablet, a laptop, etc.) of the user. Moreover, pieces of process information can be recorded in a location-specific manner, for example, the location determination can take place per GPS, and the pieces of process information can be wirelessly transmitted into a cloud-based or local farm management system. Therefore, the user can document the soil cultivation and/or remote monitoring can take place.

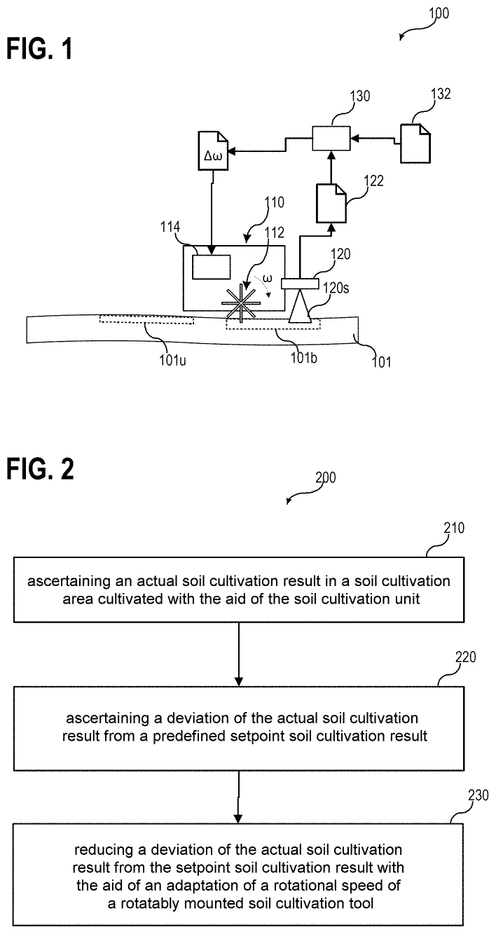

FIG. 1 illustrates a tool system 100 in a schematic view, according to different aspects of the disclosure. The tool system 100 can be mounted, for example, as a working module (also referred to as a working device), on a suitable vehicle (referred to as a carrier vehicle in this case), for example, on a tractor or another towing vehicle.

According to different aspects of the disclosure, the tool system 100 may be configured for carrying out agricultural soil cultivation. In the process, a soil area 101u, which has not yet been cultivated with the aid of the tool system 100, may be successively cultivated with the aid of the tool system 100, in that the tool system 100 may be moved in relation to the soil 101. A soil area 101b cultivated with the aid of the tool system 100 may be produced having appropriate soil properties, which can be understood to be a soil cultivation result.

According to different aspects of the disclosure, the tool system 100 may include a soil cultivation unit 110. The soil cultivation unit 110 may include at least one rotatably mounted soil cultivation tool 112. Moreover, the soil cultivation unit 110 may include an electric drive 114 (for example, an electromechanical drive system) for driving (for example, for rotating) the at least one rotatably mounted soil cultivation tool 112. According to different aspects of the disclosure, the electric drive 114 may include at least one electric motor. It is understood that the electric drive 114 and the at least one rotatably mounted soil cultivation tool 112 may be arbitrarily designed with the aid of appropriate drive technology and mounting technology in order to implement the soil cultivation function.

According to different aspects of the disclosure, the soil cultivation unit 110 may be configured in such a way that a rotational speed w of the at least one rotatably mounted soil cultivation tool 112 can be changed with the aid of the electric drive 114, for example, to a predefined value. Therefore, for example, a soil cultivation result depending on the rotational speed w may be produced in a soil cultivation area 101b cultivated with the aid of the soil cultivation unit 110. According to different aspects of the disclosure, for example, the breaking-up of the soil may be considered to be a soil cultivation result, wherein a higher rotational speed w can result, for example, in the soil being broken up to a lesser extent.

It is understood that the soil cultivation area 101b cultivated with the aid of the soil cultivation unit 110 arises in each case, during operation, behind the soil cultivation unit 110 with respect to the movement direction of the tool system 100. Therefore, an actual soil cultivation result and/or a setpoint soil cultivation result relate(s) to an area in the soil that has already been cultivated and, therefore, also to an area in the soil that is arranged behind the soil cultivation unit 110 with respect to the movement direction of the tool system 100.

According to different aspects of the disclosure, the tool system 100 may also include a sensor system 120. The sensor system 120 may include, for example, at least one sensor. Wherever useful, the sensor system 120 may include a computer system or can be communicatively coupled to a computer system, in order to detect and/or process the pieces of information gathered with the aid of the at least one sensor.

According to different aspects of the disclosure, the sensor system 120 may be configured to ascertain an actual soil cultivation result 122 in the soil cultivation area 101b cultivated with the aid of the soil cultivation unit 110. It is understood that the actual soil cultivation result 122 may be arranged behind the soil cultivation unit 110 with respect to the movement direction of the tool system 100, so that the soil cultivation area 101b, which has already been cultivated with the aid of the soil cultivation unit 110, may be scanned with the aid of a laser, optically detected with the aid of a camera, or the like.

According to different aspects of the disclosure, the sensor system 120 may have a detection range 120s, within which the pieces of information regarding the soil 101 can be gathered. The detection range 120s may be arranged, in the direction of travel (during forward motion), behind the rotatably mounted soil cultivation tool 112 of the soil cultivation unit 110.

According to different aspects of the disclosure, the tool system 100 can also include a closed-loop control system 130. The closed-loop control system 130 can be configured, for example, for changing (mw) the rotational speed w of the at least one rotatably mounted soil cultivation tool 112 based on the ascertained actual soil cultivation result 122 and a (for example, predefined) setpoint soil cultivation result 132. Therefore, for example, a deviation of the actual soil cultivation result 122 from the setpoint soil cultivation result 132 can be reduced or minimized. It is understood that the closed-loop control system 130 may therefore include one or multiple processor(s) or, for example, a computer system, in order to implement the appropriate functions of the closed-loop control. Moreover, the closed-loop control system 130 may be appropriately communicatively coupled to one or multiple processor(s) or, for example, a computer system, in order to implement the appropriate functions of the closed-loop control. Moreover, for example, a motor controller can be utilized, in order to adjust the actual rotational speed of the rotatably mounted soil cultivation tool 112 according to a predefined value, wherein the predefined value is made available to the motor controller by the closed-loop control system 130.

FIG. 2 illustrates a method 200 for agricultural soil cultivation with the aid of a soil cultivation unit, for example, with the aid of the soil cultivation unit 110 represented in FIG. 1, according to different aspects of the disclosure.

The method 200 may include, for example, the following: in 210, ascertaining an actual soil cultivation result in a soil cultivation area cultivated with the aid of the soil cultivation unit; in 220, ascertaining a deviation of the actual soil cultivation result from a (for example, predefined) setpoint soil cultivation result; and, in 230, reducing or minimizing a deviation of the actual soil cultivation result from the setpoint soil cultivation result with the aid of an adaptation of a rotational speed of a rotatably mounted soil cultivation tool.

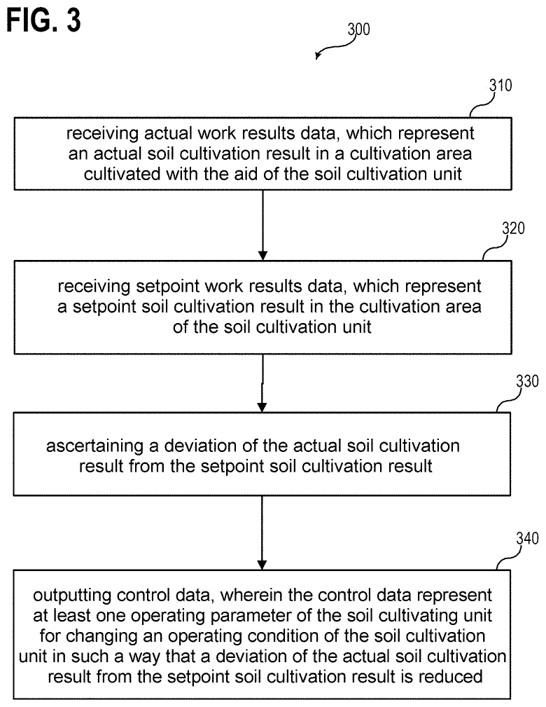

FIG. 3 illustrates a method 300 for agricultural soil cultivation with the aid of a soil cultivation unit, for example, with the aid of the soil cultivation unit 110 represented in FIG. 1, according to different aspects of the disclosure.

The closed-loop control method 300 may include, for example, the following: in 310, receiving actual work results data, which represent an actual soil cultivation result in a cultivation area cultivated with the aid of the soil cultivation unit; in 320, receiving setpoint work results data, which represent a setpoint soil cultivation result in the cultivation area of the soil cultivation unit; in 330, ascertaining a deviation of the actual soil cultivation result from the setpoint soil cultivation result; and, in 340, outputting control data, wherein the control data represent at least one operating parameter of the soil cultivating unit for changing an operating condition of the soil cultivation unit in such a way that a deviation of the actual soil cultivation result from the setpoint soil cultivation result is reduced.

According to different aspects of the disclosure, the at least one operating parameter may represent a rotational speed of a rotatably mounted soil cultivation tool 112 of the soil cultivation unit 110.

According to different aspects of the disclosure, the closed-loop control method 300 described herein may be implemented in an appropriate closed-loop control device, for example, in the form of hardware and/or software. Correspondingly, for example, a non-transitory non-volatile memory medium may include instructions, which, when executed by at least one processor, carry out the closed-loop control method.

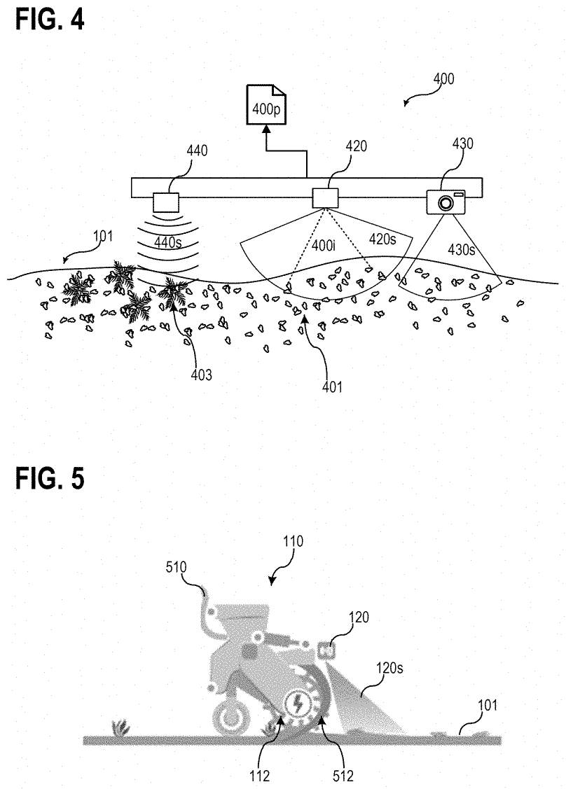

FIG. 4 illustrates a sensor system 400 in a schematic view, according to different aspects of the disclosure. The sensor system 400 may be, for example, the sensor system 120 of the tool system 100.

According to different aspects of the disclosure, the sensor system 400 may be configured to gather pieces of height information 400i and, based on the gathered pieces of height information 400i, determining a two-dimensional or three-dimensional soil profile 400p of the cultivated soil cultivation area.

For example, the sensor system 120 may include a laser sensor 420 for gathering the pieces of height information 400i. The laser sensor 420 may have a detection range 420s, wherein one or multiple laser beam(s) may be scanned over the soil 101 within the detection range 420s. It is understood that the pieces of height information 400i may therefore be processed as data; for example, the measuring data of the laser sensor 420 may be utilized for creating a two-dimensional or three-dimensional soil profile 400p of the soil 101.

According to different aspects of the disclosure, the sensor system 120 may include an optical sensor 430 for ascertaining a two-dimensional or three-dimensional soil profile 400o of the cultivated soil cultivation area. The optical sensor 430 may be, for example, a camera. The optical sensor 430 may have, for example, an image area 430s, wherein one or multiple image(s) of the soil 101 may be recorded in the image area 430s.

Moreover, the sensor system 120, according to different aspects of the disclosure, may include a radar sensor 440 for detecting one or multiple measuring variable(s), on the basis of which one or multiple soil parameter(s) may be determined. For example, reflection properties and/or adsorption properties of the soil 101 may be detected in the cultivated soil cultivation area with the aid of the radar sensor 440 (for example, by utilizing high-frequency radiation), in order to determine, on the basis thereof, for example, the crumbling 401 of the soil 101 and/or the incorporation 403 of organic mass into the soil 101. The radar sensor 440 may have, for example, a sensor range 440s, wherein radar radiation may be emitted into the sensor range 440s and radar radiation out of the sensor range 440s may be detected.

According to different aspects of the disclosure, the soil cultivation result may be the crumbing 401 of the soil 101. Moreover, alternatively to the crumbling of the soil 401 or in addition to the crumbling of the soil 401, the soil cultivation result may be the incorporation 403 of organic mass into the soil 101.

According to different aspects of the disclosure, one further sensor system may be utilized, for example, for detecting at least one soil condition of the soil 101 before the cultivation of the soil cultivation area and/or outside the cultivated soil cultivation area. The at least one soil condition of the soil may include one of the following: the plant mass on and/or in the soil, a soil surface structure, the soil moisture, and/or the soil density.

FIG. 5 illustrates a soil cultivation unit, for example, the soil cultivation unit 110 of the tool system 100, in a schematic view, according to different aspects of the disclosure.

According to different aspects of the disclosure, the soil cultivation unit 110 may include, in addition to the actively rotating soil cultivation tool 112, at least one drawn soil cultivation tool 512 for cultivating the soil 101.

According to different aspects of the disclosure, the soil cultivation unit 110 may be supplied with electric power with the aid of an electric cable 510 and an appropriate interface in order to electrically drive the rotating soil cultivation tool 112, which is electrically driven during the soil cultivation.

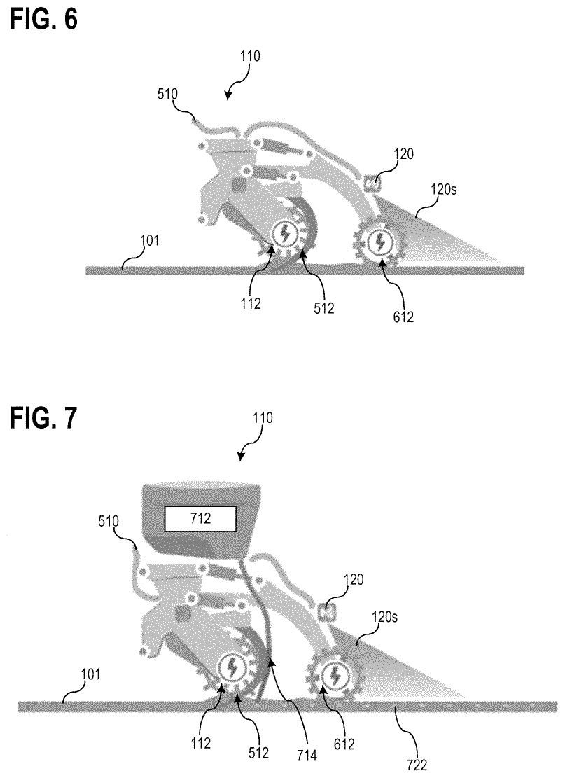

FIG. 6 illustrates a soil cultivation unit, for example, the soil cultivation unit 110 of the tool system 100, in a schematic view, according to different aspects of the disclosure.

According to different aspects of the disclosure, the soil cultivation unit 110 may also include at least one trailing tool 612. The at least one trailing tool 612 may be, for example, electrically driven in order to generate a propulsive force and/or for cultivating the soil 101. The at least one trailing tool 612 may be configured, for example, in such a way that a depth guidance of the at least one rotatably mounted soil cultivation tool 112 and/or of the at least one drawn tool 512 may be ensured.

According to different aspects of the disclosure, the soil cultivation unit 110 may be modularly designed in such a way that the soil cultivation unit 110 can be operated with the at least one trailing tool 612 and without the at least one trailing tool 612.

With the at least one trailing tool 612, as schematically illustrated in FIG. 6, for example, a crop residue cultivation and/or incorporation of liquid manure can take place. Without the at least one trailing tool 612, as schematically illustrated in FIG. 5, for example, a mechanical weeding can take place.

According to different aspects of the disclosure, the soil cultivation unit 110 may be configured in such a way that electric power supplied to the soil cultivation unit 110 with the aid of the cable 510 can also be utilized for supplying the electrically driven at least one trailing tool 612.

FIG. 7 illustrates a soil cultivation unit, for example, the soil cultivation unit 110 of the tool system 100, in a schematic view, according to different aspects of the disclosure.

According to different aspects of the disclosure, a seed container 712 may be mounted on the soil cultivation unit 110. Moreover, a device 714 for incorporating seed 722 from the seed container 712 into the soil 101 may be installed. Therefore, the seed 722 may be incorporated in the soil 101, for example, already during the cultivation of the soil 101 with the aid of the soil cultivation unit 110.

With the aid of the configuration of the modular soil cultivation unit 110 illustrated in FIG. 7, for example, a seedbed cultivation with sowing can take place.

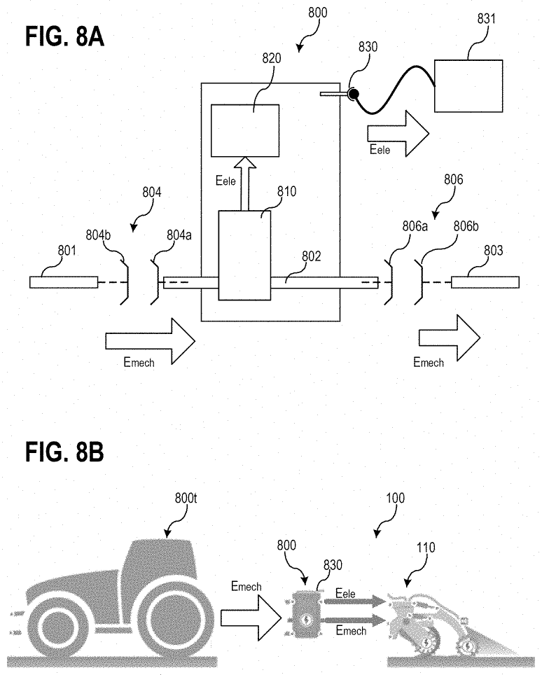

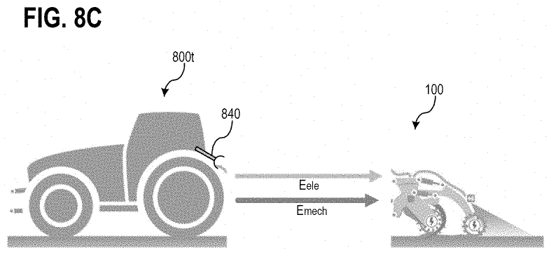

FIG. 8A illustrates a generator module 800 in a schematic view, according to different aspects of the disclosure.

The generator module 800 may include, for example, a shaft 802 and a first coupling element 804a for coupling 804 the shaft 802 to a driven shaft 801 (for example, a power take-off shaft of a tractor or another carrier vehicle) for supplying mechanical energy E_{mech} into the generator module 800. The driven shaft 801 may include, for example, a further coupling element 804b, which matches the first coupling element 804a, for coupling 804 the shaft 802 of the generator module 800 to the driven shaft 801.

Moreover, the generator module 800 may include a second coupling element 806a for coupling 806 a shaft 803, which is to be driven, to the shaft 802 of the generator module 800. The shaft 803 to be driven may include, for example, a further coupling element 806b, which matches the second coupling element 806a.

According to different aspects of the disclosure, the second coupling element 806a of the generator module 800 may be designed in the same way or a similar way as the coupling element 804b of the driven shaft 801, so that mechanical energy E_{mech} may be conducted partially through the generator module 800 to a consumer. In other words, the generator module 800 may be switched between a driven shaft 801 and a shaft 803 to be driven. Therefore, mechanical energy E_{mech} may also be made available with the aid of the generator module 800.

According to different aspects of the disclosure, the generator module 800 may include at least one generator 810 coupled to the shaft 802 for generating electrical energy Eₑₗₑ from a portion of the supplied mechanical energy E_{mech}.

According to different aspects of the disclosure, the generator module 800 may include an electrical energy store 820 for storing the generated electrical energy Eₑₗₑ.

Moreover, the generator module 800 may include an electrical interface 830 for supplying an electric drive 831 coupled to the electrical interface 803 directly with the generated electrical energy Eₑₗₑ or with the electrical energy Eₑₗₑ stored in the electrical energy store 820.

According to different aspects of the disclosure, the generator module 800 may be utilized for supplying a soil cultivation unit, for example, the soil cultivation unit 110 of the tool system 100, with electrical energy Eₑₗₑ. For example, the electric drive of the rotatably mounted soil cultivation tool 112 and/or of the trailing tool 612 can be supplied with electrical energy Eₑₗₑ, as necessary, with the aid of the generator module 800. This may be necessary, for example, when a carrier vehicle is not designed for an energy supply of the type illustrated, for example, in FIG. 8B, but rather includes a driven shaft 801.

FIG. 8B illustrates the carrier vehicle 800t and a tool system, for example, the tool system 100, according to different aspects of the disclosure. According to different aspects of the disclosure, a generator module 800 is mounted on the carrier vehicle 800t in order to supply the tool system 100 with electrical energy Eₑₗₑ.

According to different aspects of the disclosure, the carrier vehicle 800t and the generator module 800 may be configured in such a way that the mechanical energy E_{mech} is made available with the aid of the carrier vehicle 800t and is transmitted to the generator module 800 coupled thereto. The tool system 100 may obtain, for example, electrical energy Eₑₗₑ with the aid of an electrical connection to the interface 830 of the generator module 800. Therefore, for example, at least one electric drive of the soil cultivation unit 110 or of the tool system 100 can be supplied with electrical energy Eₑₗₑ.

Provided the carrier vehicle 800t is designed in such a way that it can also provide a sufficient amount of electrical energy Eₑₗₑ for the soil cultivation unit 110 without the generator module 800, the soil cultivation unit 110 may be coupled directly to an appropriate electrical interface 840 of the carrier vehicle 800t and, therefore, can be supplied with electrical energy Eₑₗₑ by the carrier vehicle 800t, as illustrated in FIG. 8C.

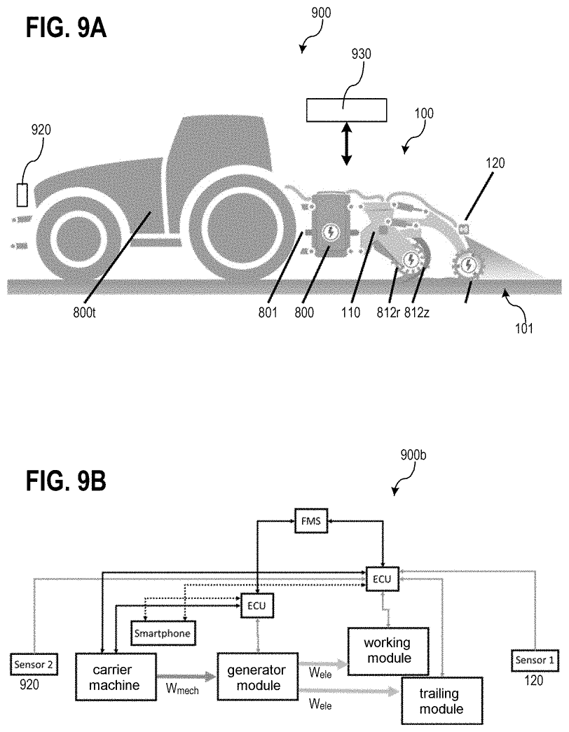

FIG. 9A illustrates a vehicle/equipment combination 900 made up of a carrier vehicle (also referred to as a carrier machine) 800t and a tool system 100, wherein the tool system 100 is supplied with electrical energy with the aid of a generator module 800, wherein mechanical energy is supplied to the generator module 800 with the aid of a universal joint shaft 801 of the carrier vehicle 800t. The tool system 100 may include an electrically driven soil cultivation unit (also referred to as a working module) 110. The soil cultivation unit 110 may be configured to cultivate the soil 101 with the aid of electrically driven, rotating tines 812r (as an example of a rotatably mounted soil cultivation tool) and, optionally, with the aid of drawn tines 812z (as an example of a drawn tool). Moreover, the soil 101 may be cultivated with the aid of an electrically driven trailing tool (also referred to as a trailing module) 612. The soil cultivation unit 110 may include, for example, a sensor 120 for ascertaining a soil cultivation result with the aid of an appropriately designed closed-loop control device 930. The sensor 120 for ascertaining the soil cultivation result can be mounted at the rear of the vehicle/equipment combination 900 or at the rear of the tool system 100. An additional sensor 920 may be mounted at the front of the vehicle/equipment combination 900 or at the front of the carrier vehicle 800t. With the aid of the additional sensor 920, for example, soil properties may be ascertained before the cultivation of the soil 101.

FIG. 9B shows a block diagram 900b of an exemplary power distribution and communication of the pieces of open-loop/closed-loop control information, according to different aspects of the disclosure.

According to different aspects of the disclosure, mechanical power W_{mech} (similarly to mechanical energy E_{mech}) may be transmitted from the carrier vehicle 800t to the generator module 800. With the aid of the generator module 800, electric power Wₑₗₑ (similarly to electrical energy Eₑₗₑ) may be generated and transmitted to the working module and to the trailing module.

A computer system (for example, a control unit ECU of the carrier vehicle 800t and/or a control unit of the working module) may carry out appropriate open-loop/closed-loop control functions. For this purpose, the computer system may be communicatively coupled to the particular components in order to transmit the open-loop/closed-loop control signals and/or the sensor signals. For example, the computer system may be communicatively coupled, via a bus system, to the generator module 800, the working module 110, the trailing module 612, the sensor 120, and, optionally, the additional sensor 920. External open-loop/closed-loop control signals and/or external sensor signals may be taken into account with the aid of a decentralized system (for example, a FMS, Farm Management System) and the computer system; for example, the computer system can be communicatively coupled to the carrier machine and to the FMS for this purpose. Optionally, data may be exchanged between the computer system and a mobile device (for example, a smartphone, a tablet, etc.), for example, in order to output data to a user or for the input of data by a user.

According to different aspects of the disclosure, the computer system may be made available locally in the carrier vehicle 800t. Alternatively, however, a decentralized data processing may be implemented, in the case of which the data are appropriately transmitted with the aid of transmitters and receivers.

Optional details of a generator module are described in the following. The generator module may include, for example, a mechanical coupling interface to the carrier vehicle (for example, to a tractor) and a mechanical coupling interface for a working device, to which mechanical power is to be supplied.

The generator module may be coupled, for example, to the mechanical power take-off shaft of the carrier vehicle (for example, of a tractor). The generator module may be configured to convert at least one portion of the supplied mechanical power into electric power. The mechanical power may be transmitted with the aid of a transmission to at least one generator of the generator module. The transmission can be designed, for example, in such a way that a mechanical through-drive may take place, for example, in order to provide mechanical power through the generator module if necessary.

According to different aspects of the disclosure, a hybrid power supply may be achieved with the aid of the generator module. The electrical power supply can be effectuated, for example, with the aid of a DC interface. For example, a (for example, standardized) AEF (Agricultural Industry Electronics Foundation) electrical outlet may be utilized as an interface for the electric power. The mechanical power supply may be effectuated with the aid of a (for example, standardized) P.T.O. shaft spline.

According to different aspects of the disclosure, the generator module may be connected to the carrier vehicle via cable (for example, standardized) for the open-loop control. An open-loop control and/or a monitoring may be effectuated, for example, by the user, for example, with the aid of a carrier vehicle-specific data bus terminal, for example, an ISOBUS terminal. Alternatively or additionally, the open-loop control and/or the monitoring may be effectuated via smartphone, tablet, or similar mobile devices.

According to different aspects of the disclosure, process data may be transmitted to the farm management system (FMS) for the monitoring, documentation, and optimization of soil cultivation processes.

An internal communication of the particular components (for example, of the sensors, engine control signals, etc.) may take place, for example, with the aid of a CAN (Controller Area Network) network.

Optional details of a working module are described in the following. The working module may include one or multiple rotating tool(s) as well as one or multiple drawn tool(s). An optional trailing tool may be utilized, for example, for depth guidance. Moreover, the trailing tool may be configured for generating propulsive force with the aid of an electric drive.

According to different aspects of the disclosure, a sensor unit of the working module may an ascertain the work result, for example, a of the soil and/or an incorporation of organic material into the soil.

The working module may be or will be connected to a carrier vehicle (for example, a tractor) via cable (for example, standardized), for example, for the open-loop control. An open-loop control and/or a monitoring of the working module may be effectuated by a user, for example, with the aid of a carrier vehicle-specific data bus terminal, for example, an ISOBUS terminal. Alternatively or additionally, an open-loop control and/or a monitoring may be effectuated by the user via smartphone, tablet, etc.

According to different aspects of the disclosure, the user may define default values for the work result or specify the target variables on the basis of predefined data (for example, on the basis of a map including location-specific default values, on the basis of an individually created user profile, etc.).

With the aid of a sensor system, for example, actual variables, which represent the soil cultivation result, may be detected and/or ascertained. Provided that the actual variables are not determined by the computer system (for example, the control unit ECU of the carrier vehicle and/or the control unit of the working module), the actual variables may be transmitted from an external source to the computer system.

The computer system may be configured, for example, to compare the particular actual value with an associated setpoint value and, for example, adapting the rotational speed of the cultivation tool and/or the trailing tool. The trailing tool may be designed as a process module.

According to different aspects of the disclosure, for example, a ground speed of the overall system may be determined. For this purpose, the working module and/or the generator module may include an appropriate GPS (Global Positioning System) device for determining a movement in GPS coordinates.

According to different aspects of the disclosure, a closed-loop control of the working module does not need to be implemented locally, but rather may be implemented, for example, as part of the farm management system. A transmission of the process data of the working module to the farm management system (FMS) may also take place for the purpose of monitoring, documentation and/or optimization.

According to different aspects of the disclosure, the work result may be determined with the aid of a LIDAR (Light Detection And Ranging) laser sensor. The LIDAR laser sensor and/or another sensor may be mounted, for example, at the rear of the working module. Based on the measuring data of the LIDAR laser sensor and/or another sensor, for example, a 2D profile of the work result may be created. Based on the pieces of height information of the 2D profile, for example, the breaking-up of the soil may be ascertained. The incorporation of organic mass may be determined, for example, based on color intensity information of the 2D profile.

According to different aspects of the disclosure, a radar sensor can be utilized as an alternative or in addition to a LIDAR sensor. The breaking-up of the soil and/or the incorporation may be ascertained, for example, based on the reflection and/or adsorption of the radar radiation (for example, of a high-frequency radiation). Moreover, an additional radar sensor may be utilized, which may be mounted at the front of the carrier vehicle or at the front of the working module in order to determine the plant mass and/or the soil surface structure (for example, the soil moisture and/or the soil density).

According to different aspects of the disclosure, the pieces of information of a radar unit may be utilized for the closed-loop control of the rotational speeds of the process unit (for example, of the soil cultivation unit 110) and/or of the trailing tool. According to different aspects of the disclosure, the working module may include a DC interface, for example, including a (for example, standardized) AEF electrical outlet for the electrical power uptake either from the carrier vehicle directly or from the generator module.

According to different aspects of the disclosure, the working module-internal, tool system-internal and/or the vehicle/equipment combination-internal communication of the particular components may take place with the aid of a CAN network.

According to different aspects of the disclosure, the working module or the tool system may be modularly designed and include multiple function-specific modules. Therefore, the working module may be adapted to different application scenarios, for example, in one variant, for crop residue cultivation and/or incorporation of liquid manure (see, for example, FIG. 6); in another variant (without a trailing tool), for mechanical weeding (see, for example, FIG. 5); and in one further variant (including an additional application unit for sowing), for applying plant seeds (see, for example, FIG. 7).

Different examples are described in the following, which can relate to that which has been described above and/or to that which is represented in the figures.

Example 1 is a tool system 100 for agricultural soil cultivation, wherein the tool system includes: a soil cultivation unit 110 including at least one rotatably mounted soil cultivation tool 112 and an electric drive 114 for rotating the at least one rotatably mounted soil cultivation tool 112, wherein the soil cultivation unit 110 is configured to change a rotational speed w of the at least one rotatably mounted soil cultivation tool 112 with the aid of the electric drive 114, in order to generate a soil cultivation result depending on the rotational speed w in a soil cultivation area 101b cultivated with the aid of the soil cultivation unit 110; a sensor system 120, which is configured to determine an actual soil cultivation result 122 in the soil cultivation area 101b cultivated with the aid of the soil cultivation unit 110; and a closed-loop control system 130, which is configured to change the rotational speed w of the at least one rotatably mounted soil cultivation tool 112 based on the ascertained actual soil cultivation result 122 and a (for example, predefined) setpoint soil cultivation result 132, in order to reduce a deviation of the actual soil cultivation result 122 from the setpoint soil cultivation result 132.

In example 2, the tool system 100 according to example 1 may also include the feature that the sensor system 120 is configured to gather pieces of height information 400i and, based on the gathered pieces of height information 400i, determining a two-dimensional or three-dimensional soil profile 400p of the cultivated soil cultivation area 101b.

In example 3, the tool system 100 according to example 2 may also include the feature that the sensor system 120 includes a laser sensor 420 for gathering the pieces of height information 400i.

In example 4, the tool system 100 according to one of examples 1 through 3 may also include the feature that the sensor system 120 includes an optical sensor 430. The optical sensor 430 may be configured in such a way that a two-dimensional or three-dimensional soil profile 400p of the cultivated soil cultivation area 101b may be determined.

In example 5, the tool system 100 according to one of examples 1 through 4 may also include the feature that the soil cultivation result is a soil breaking-up 401 of the soil 101.

In example 6, the tool system 100 according to one of examples 1 through 5 may also include the feature that the soil cultivation result is the incorporation of organic mass 403 into the soil 101.

In example 7, the tool system 100 according to one of examples 1 through 6 may also include the feature that the sensor system 120 includes a radar sensor 440. The radar sensor 440 may be configured in such a way that reflection properties and/or adsorption properties of the soil may be determined with the aid of radar radiation (for example, with the aid of high-frequency radiation) and, based thereon, determining the soil breaking-up 401 of the soil 101 and/or the incorporation of organic mass 403 into the soil 101.

In example 8, the tool system 100 according to one of examples 1 through 7 may also include: a further sensor system 920, which is configured to determine at least one soil condition of the soil 101 before the cultivation of the soil cultivation area and/or outside the cultivated soil cultivation area 101b.

In example 9, the tool system 100 according to example 8 may also include the feature that the at least one soil condition of the soil 101 includes or is one of the following: the plant mass on and/or in the soil, a soil surface structure, the soil moisture, and/or the soil density.

In example 10, the tool system 100 according to one of examples 1 through 9 may also include the feature that the soil cultivation unit 110 also includes at least one drawn tool 512 for cultivating the soil 101.

In example 11, the tool system 100 according to one of examples 1 through 10 may also include the feature that the soil cultivation unit 110 also includes at least one trailing tool 612, wherein the at least one trailing tool 612 is electrically driven, in order to generate a propulsive force. The at least one trailing tool 612 may be configured for the depth guidance of the at least one rotatably mounted soil cultivation tool 110 and/or for the depth guidance of the at least one drawn tool 512.

In example 12, the tool system 100 according to example 11 may also include the feature that the soil cultivation unit 110 is modularly designed in such a way that it may be operated with and without the at least one trailing tool.

In example 13, the tool system 100 according to one of examples 1 through 12 may also include: a seed container 712 and a device 714 for introducing seed from the seed container 712 into the soil 101 during the cultivation of the soil 101 with the aid of the soil cultivation unit 110.

In example 14, the tool system 100 according to one of examples 1 through 13 may also include: a generator module 800 for supplying the electric drive with electrical energy, wherein the generator module 800 includes at least one generator 810 for generating the electrical energy, preferably for converting mechanical energy supplied by the generator module 800 into electrical energy.

In example 15, the tool system 100 according to example 14 may also include the feature that the generator module 800 includes at least one energy store 820 for storing the generated electrical energy.

Example 16 is a carrier vehicle 800t and a tool system 100 coupled to the carrier vehicle according to one of examples 1 through 13, wherein the carrier vehicle 800t includes at least one energy supply and is configured for supplying the electric drive of the tool system 100 with electrical energy.

Example 17 is a carrier vehicle 800t and a tool system 100 coupled to the carrier vehicle 800t according to example 14 or 15, wherein the carrier vehicle 800t includes a driven shaft 801 and is configured for supplying mechanical energy to the generator module 800 with the aid of the driven shaft 801. According to different aspects of the disclosure, the generator module 800 may be configured in such a way that a portion of the supplied mechanical energy is forwarded to the tool system 100 coupled to the carrier vehicle 800t. In this case, the tool system 100 may be configured for providing a portion of the drive of the tool (for example, of the soil cultivation tool 112 of the soil cultivation unit 110 and/or of the trailing vehicle 612 of the soil cultivation unit 110) and/or of the propulsion (for example, generated by the soil cultivation tool 112 of the soil cultivation unit 110 and/or the trailing tool 612 of the soil cultivation unit 110) based on the supplied mechanical energy.

Example 18 is a generator module 800 including: a shaft 802, a first coupling element 804a for coupling the shaft 802 to a driven shaft 801 for supplying mechanical energy into the generator module 800; a second coupling element 806a coupled to the shaft 802 for coupling the shaft 802 to a shaft 803, which is to be driven, for providing mechanical energy with the aid of the generator module 800; at least one generator 810 coupled to the shaft 802 for generating electrical energy from the supplied mechanical energy; and an electrical interface 830 for supplying an electric drive coupled to the electrical interface 830 with the electrical energy.

In example 19, the generator module 800 according to example 18 may also include: an electrical energy store 820 for storing the generated electrical energy.

In example 20, the generator module 800 according to example 18 or 19 may also include: a transmission, with the aid of which the shaft 802 and the at least one generator 810 are coupled to one another.

In example 21, the generator module 800 according to one of examples 18 through 20 may also include the feature that the electrical interface 830 is a DC voltage interface.

Example 22 is a method for agricultural soil cultivation with the aid of a soil cultivation unit, the method including: ascertaining an actual soil cultivation result in a soil cultivation area cultivated with the aid of the soil cultivation unit; ascertaining a deviation of the actual soil cultivation result from a predefined setpoint soil cultivation result; and reducing or minimizing a deviation of the actual soil cultivation result from the setpoint soil cultivation result with the aid of an adaptation of a rotational speed of a rotatably mounted soil cultivation tool.

Example 23 is a closed-loop control method for agricultural soil cultivation with the aid of a soil cultivation unit, the closed-loop control method including: receiving actual work results data, which represent an actual soil cultivation result in a cultivation area cultivated with the aid of the soil cultivation unit; receiving setpoint work results data, which represent a setpoint soil cultivation result in the cultivation area of the soil cultivation unit; ascertaining a deviation of the actual soil cultivation result from the setpoint soil cultivation result; and outputting control data, wherein the control data represent at least one operating parameter of the soil cultivating unit for changing an operating condition of the soil cultivation unit in such a way that a deviation of the actual soil cultivation result from the setpoint soil cultivation result is reduced or minimized.

In example 24, the closed-loop control method according to example 23 may also include the feature that the at least one operating parameter represents a rotational speed of a rotatably mounted soil cultivation tool of the soil cultivation unit.

Example 25 is a non-volatile memory medium including instructions, which, executed by at least one processor, carry out the method according to one of examples 22 through 24.

According to different aspects of the disclosure, the soil cultivation tool may be configured in such a way that (for example, rotating) elements of the soil cultivation tool engage, in sections, into the soil.

It is understood that functions, algorithms, etc., which are described herein with reference to a method may also be implemented in a similar manner in a closed-loop control device, and vice versa.

What is claimed is:

1. A tool system for agricultural soil cultivation, the tool system comprising:
a soil cultivation unit comprising at least one rotatably mounted soil cultivation tool and an electric drive for rotating the at least one rotatably mounted soil cultivation tool, wherein the soil cultivation unit is configured to change a rotational speed of the at least one rotatably mounted soil cultivation tool with the aid of the electric drive, in order to generate a soil cultivation result depending on the rotational speed in a soil cultivation area cultivated with the aid of the soil cultivation unit;
a sensor system, which is configured to ascertain an actual soil cultivation result in the soil cultivation area cultivated with the aid of the soil cultivation unit; and
a closed-loop control system, which is configured to change the rotational speed of the at least one rotatably mounted soil cultivation tool based on the ascertained actual soil cultivation result and a setpoint soil cultivation result, in order to reduce a deviation of the actual soil cultivation result from the setpoint soil cultivation result.

2. The tool system as claimed in claim 1,
wherein the sensor system is configured to gather height information and, based on the height information, determining the actual soil cultivation result.

3. The tool system as claimed in claim 1,
wherein the sensor system comprises a laser sensor for ascertaining the actual soil cultivation result.

4. The tool system as claimed in claim 1,
wherein the sensor system comprises an optical sensor for ascertaining the actual soil cultivation result.

5. The tool system as claimed in claim 1,
wherein the sensor system comprises a radar sensor for ascertaining the actual soil cultivation result.

6. The tool system as claimed in claim 5,
wherein the radar sensor is configured in such a way that reflection properties and/or adsorption properties of the soil can be determined with the aid of radar radiation.

7. The tool system as claimed in claim 1,
wherein the sensor system is configured in such a way that a two-dimensional or three-dimensional soil profile of the cultivated soil cultivation area can be determined.

8. The tool system as claimed in claim 1,
wherein the soil cultivation result is a soil breaking-up of the soil; and/or
wherein the soil cultivation result is an incorporation of organic mass into the soil.

9. The tool system as claimed in claim 1,
wherein the soil cultivation unit also comprises at least one drawn tool for cultivating the soil.

10. The tool system as claimed in claim 1,
wherein the soil cultivation unit also comprises at least one trailing tool, wherein the at least one trailing tool is electrically driven, in order to generate a propulsive force.

11. The tool system as claimed in claim 10,
wherein the at least one trailing tool is configured for the depth guidance of the at least one rotatably mounted soil cultivation tool and/or for the depth guidance of at least one drawn tool.

12. The tool system according to claim 1, also comprising:
a generator module for supplying the electric drive with electrical energy, wherein the generator module comprises a generator for generating the electrical energy for converting mechanical energy supplied by the generator module into electrical energy.

13. The tool system according to claim 1, also comprising:
a further sensor system, which is configured to determine at least one soil condition of the soil before the cultivation of the soil cultivation area and/or outside the cultivated soil cultivation area.

14. The tool system as claimed in claim 13,
wherein the at least one soil condition of the soil includes or is one of the following: the plant mass on and/or in the soil, a soil surface structure, the soil moisture, and/or the soil density.

15. A carrier vehicle and a tool system coupled to the carrier vehicle as claimed in claim 12,
wherein the carrier vehicle comprises a driven shaft and is configured to supply mechanical energy to the generator module with the aid of the driven shaft.

16. The carrier vehicle as claimed in claim 15,
wherein the generator module is configured in such a way that a portion of the supplied mechanical energy is forwarded to the tool system coupled to the carrier vehicle.

17. A closed-loop control method for agricultural soil cultivation with the aid of a soil cultivation unit, the closed-loop control method including:
receiving actual working result data, which represent an actual soil cultivation result in a cultivation area cultivated with the aid of the soil cultivation unit;
receiving setpoint working result data, which represent a setpoint soil cultivation result in the cultivation area of the soil cultivation unit;
ascertaining a deviation of the actual soil cultivation result from a setpoint soil cultivation result; and
outputting control data, wherein the control data represent at least one operating parameter of the soil cultivating unit for changing an operating condition of the soil cultivation unit in such a way that a deviation of the actual soil cultivation result from the setpoint soil cultivation result is reduced.

18. The closed-loop control method as claimed in claim 17,
wherein the at least one operating parameter represents a rotational speed of a rotatably mounted soil cultivation tool of the soil cultivation unit.

19. A method for agricultural soil cultivation with the aid of a soil cultivation unit, the method including:
ascertaining an actual soil cultivation result in a soil cultivation area cultivated with the aid of the soil cultivation unit;
ascertaining a deviation of the actual soil cultivation result from a predefined setpoint soil cultivation result; and
reducing a deviation of the actual soil cultivation result from the setpoint soil cultivation result with the aid of an adaptation of a rotational speed of a rotatably mounted soil cultivation tool.

20. A non-transitory computer readable medium including instructions, which, when executed by at least one processor, cause the at least one processor to:
receive actual working result data, which represent an actual soil cultivation result in a cultivation area cultivated with the aid of the soil cultivation unit;
receive setpoint working result data, which represent a setpoint soil cultivation result in the cultivation area of the soil cultivation unit;
ascertain a deviation of the actual soil cultivation result from a setpoint soil cultivation result; and
output control data, wherein the control data represent at least one operating parameter of the soil cultivating unit for changing an operating condition of the soil cultivation unit in such a way that a deviation of the actual soil cultivation result from the setpoint soil cultivation result is reduced.
